(19) United States
(12) Patent Application Publication
(10) Pub. No.: US 2004/0234057 A1
(43) Pub. Date: Nov. 25, 2004

(54) Methods and systems for providing an on call service

(76) Inventor: Evan John Kaye, New York, NY (US)

Correspondence Address: MORGAN LEWIS & BOCKIUS LLP, 1111 PENNSYLVANIA AVENUE NW, WASHINGTON, DC, 20004, US

(21) Appl. No.: 10/799,228

(22) Filed: Mar. 12, 2004

Related U.S. Application Data
(60) Provisional application No. 60/454,423, filed on Mar. 13, 2003.

(51) Int. Cl. H04M 3/42

(52) U.S. Cl. 379/201.01; 379/201.03

(57) ABSTRACT

A preferred embodiment of the subject invention comprises a method for scheduling call consultations, comprising: receiving an electronic request from a first participant for one or more on call dates; assigning one or more on call dates to the participant; and notifying potential callers of the first participant's on call dates and qualifications. In other embodiments, the invention comprises the method above, as well as: receiving electronic feedback information from one or more callers who have called the first participant during the one or more assigned on call dates; and recording the feedback information in an electronic database and/or assigning the participant to a group associated with a topic. In a further embodiment, the method comprises associating the participant with a topic, wherein a predetermined number of callers have expressed interest in the topic, and wherein the participant has received positive feedback for calls related to the topic.

### CROSS-REFERENCE TO RELATED APPLICATIONS

This application claims priority to U.S. provisional patent application No. 60/454,423, filed Mar. 13, 2003. The entire contents of that application are incorporated herein by reference.

### BACKGROUND

Phone consultations usually are set up by a coordinator who finds an expert on a given topic and schedules a mutually convenient time for the client and the consultant expert. After the call takes place, the coordinator usually pays the consultant and receives payment from the caller.

In addition to such phone consultations, there are call rosters whereby a physician, for instance, may be on call for a given specialty and other physicians or healthcare professionals that need the help of a practitioner in the specialty may call that physician during the time that they are on call. Such a roster is usually created manually and either physically or electronically disseminated.

The scenarios referred to above rely on the coordinator (in the former) and the person drawing up the schedule (in the latter) to decide who is to be made available on a given topic at a given time. Feedback from the callers is not automatically incorporated into deciding who should be made available when, and on what topic.

What is needed is an automated system that monitors the topics that callers have shown an interest in and suggests consultants with whom they might like to consult.

### SUMMARY

A preferred embodiment of the subject invention comprises a method for scheduling call consultations, comprising: receiving an electronic request from a first participant for one or more on call dates; assigning one or more on call dates to the participant; and notifying potential callers of the first participant's on call dates and qualifications. In other embodiments, the invention comprises the method above, as well as: receiving electronic feedback information from one or more callers who have called the first participant during the one or more assigned on call dates; and recording the feedback information in an electronic database and/or assigning the participant to a group associated with a topic, wherein a potential caller does not have access to contact information for the participant unless the potential caller has indicated an interest in the topic. In further embodiments, the interest is indicated by the potential caller requesting to speak with a associated with the topic; the interest is indicated by the potential caller attending one or more events associated with the topic; and/or the interest is indicated by the potential caller downloading one or more publications related to the topic. In a further embodiment, the method comprises associating the participant with a topic, wherein a predetermined number of callers have expressed interest in the topic, and wherein the participant has received positive feedback for one or more calls related to the topic; and transmitting an electronic invitation to the participant to request an on call date relating to the topic.

### BRIEF DESCRIPTION OF THE DRAWINGS

FIGS. 1A and 1B depict steps of a preferred method embodiment.

FIGS. 2A and 2B depict steps of an alternate embodiment.

FIG. 3 depicts components of a preferred system embodiment.

FIG. 4 depicts a consultant registration page of a preferred embodiment.

FIG. 5 depicts a groups currently on call page of a preferred embodiment.

FIG. 6 depicts a group details page of a preferred embodiment.

FIG. 7 depicts an invitation generation page of a preferred embodiment.

FIG. 8 depicts an exemplary email invitation of a preferred embodiment.

FIG. 9 depicts a calendar web page of a preferred embodiment.

FIG. 10 depicts a contact information page of a preferred embodiment.

FIG. 11 depicts an exemplary confirmation request email of a preferred embodiment.

FIG. 12 depicts a confirmation page of a preferred embodiment.

FIG. 13 depicts an administrator's calendar page of a preferred embodiment.

FIG. 14 depicts a participant on call page of a preferred embodiment.

FIG. 15 depicts an exemplary on call cancellation email of a preferred embodiment.

FIG. 16 depicts an exemplary advisors on call email of a preferred embodiment.

FIG. 17 depicts an electronic invoice page of a preferred embodiment.

FIG. 18 depicts an exemplary invoice confirmation email of a preferred embodiment.

FIG. 19 depicts an exemplary call feedback request email of a preferred embodiment.

FIG. 20 depicts a feedback form page of a preferred embodiment.

FIG. 21 depicts an aggregated electronic invoice page of a preferred embodiment.

FIG. 22 depicts an administrator's feedback screen of a preferred embodiment.

FIG. 23 depicts a caller's calendar page of a preferred embodiment.

FIG. 24 depicts a group details page of a preferred embodiment wherein the group is attached to a topic.

FIG. 25 depicts an exemplary advisors on call email of a preferred embodiment wherein the recipient has expressed interest in a matching topic.

### DETAILED DESCRIPTION OF PREFERRED EMBODIMENTS

A preferred embodiment of the invention comprises systems and methods for contacting participants for an on call service, construction of an on call roster, and distribution of the roster to prospective callers who may decide to call on a participant.

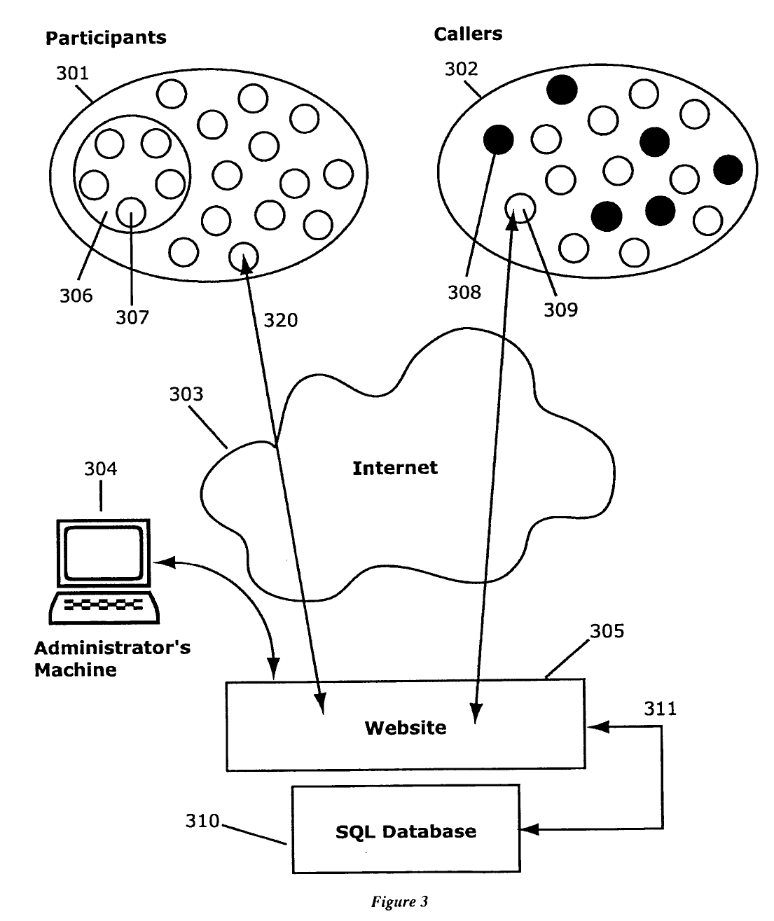

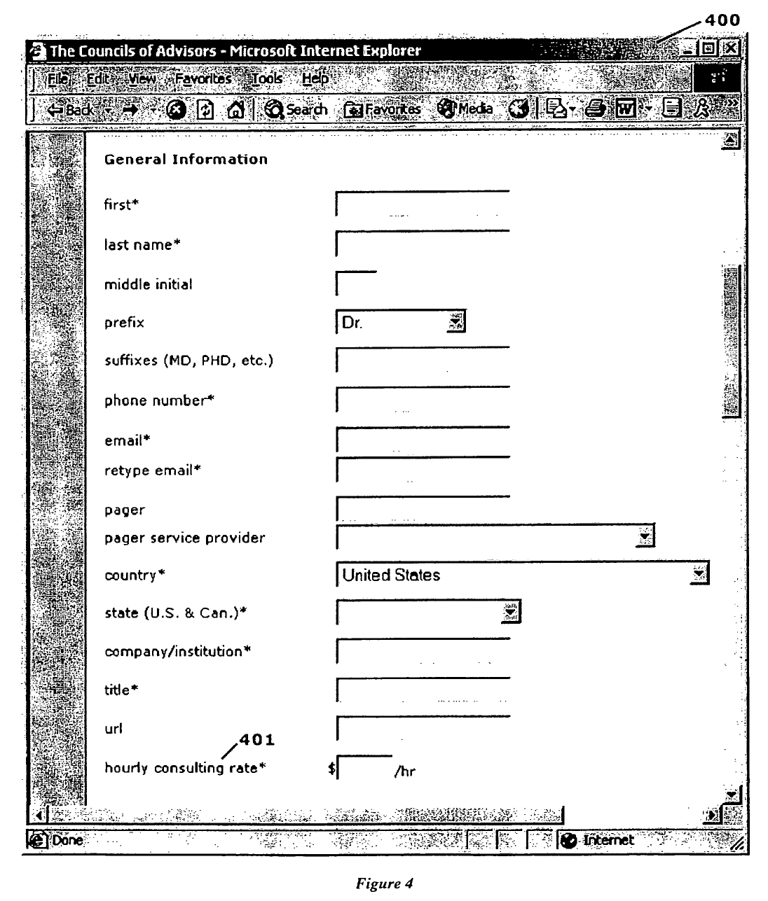

Components of a preferred system embodiment are depicted in FIG. 3. Participants 301 may be consultants who are paid by the hour. They preferably give notice of their availability by having previously registered on a website 305 via the Internet 303 and have entered their hourly rate 401 (see FIG. 4) on a web form 400, which is then submitted together with their biographical details and expertise to a SQL database 310.

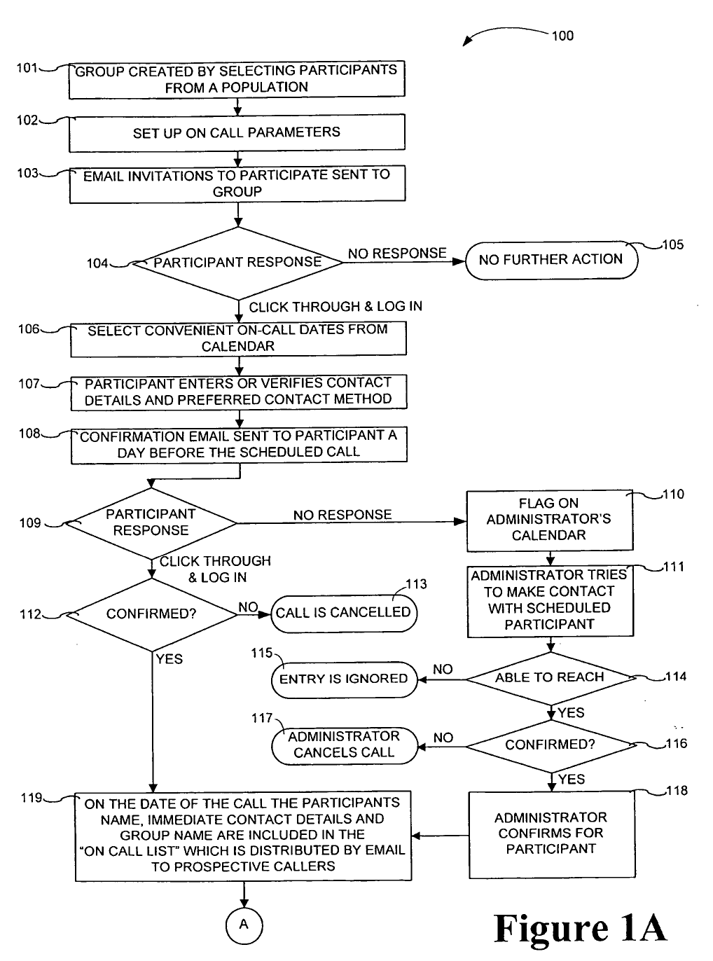

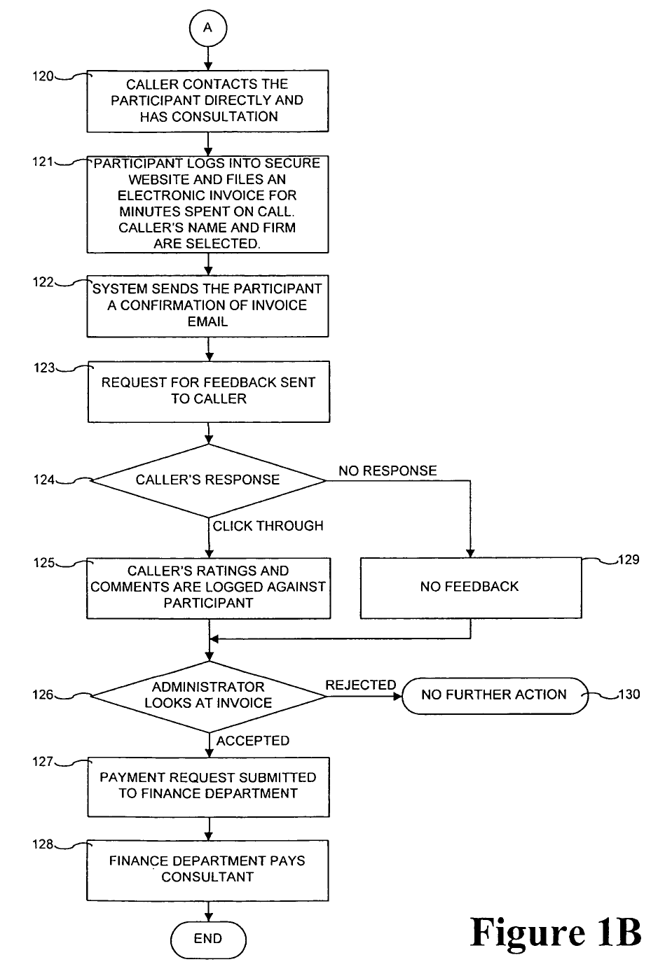

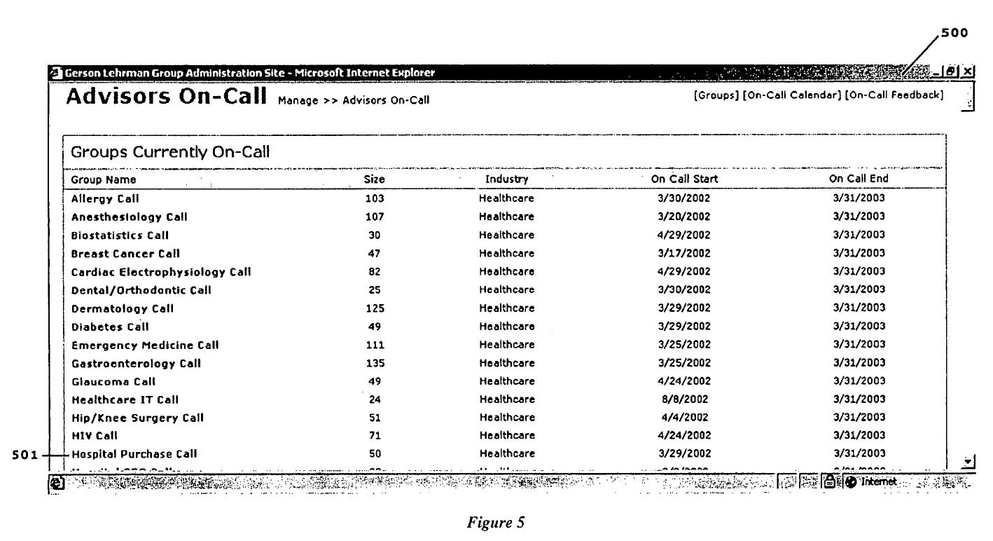

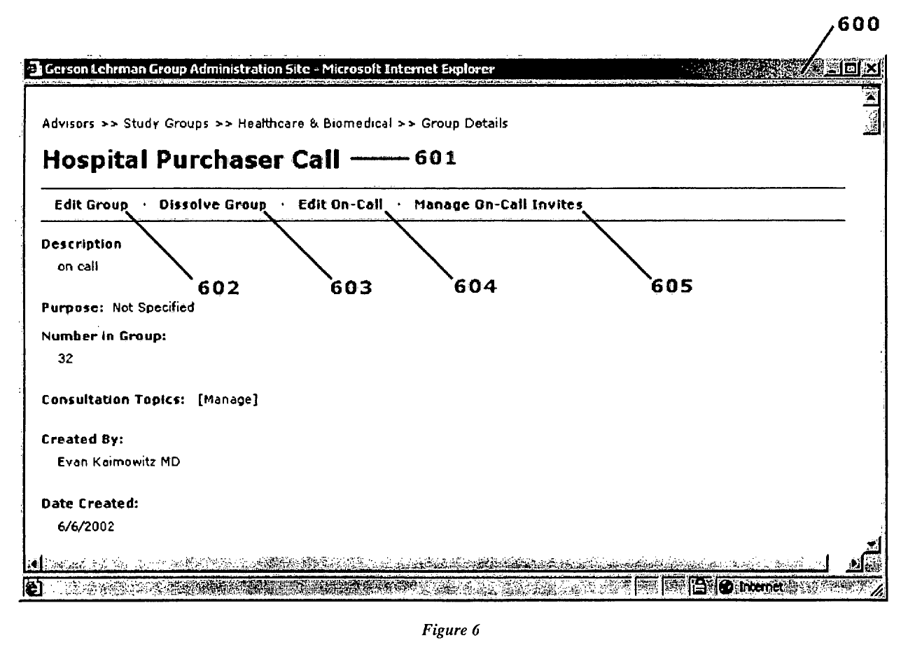

With reference now to the flowchart in FIG. 1A, an administrator 304 can, via the Internet 303 and website 305, at step 101 group participants 306 according to their expertise and store the groups in the SQL database 310. Such groups are given names and are listed on the website 305 as shown in FIG. 5. By selecting an individual group 501, an administrator 304 can view a web page 600 (see FIG. 6) with more details and statistics on a specific group 601.

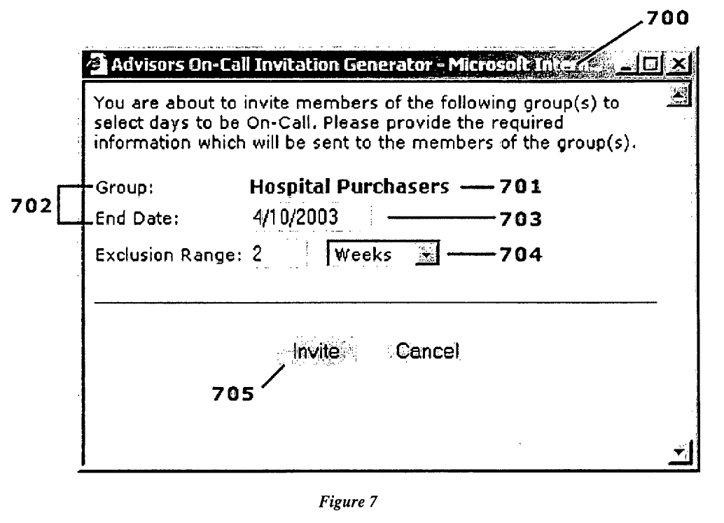

From the detailed web page 600 the administrator 304 may elect to Edit (602) the group or Dissolve (delete) (603) the group. By electing at step 102 (see FIG. 1A) to Edit On Call parameters (604), the administrator is directed to a screen 700 (see FIG. 7) specific for that group (701) which has editable fields 702. End Date (703) is the last day on which call dates are permitted. Exclusion Range (704) is the time period after a call date when a participant 307 will not be allowed to have another call.

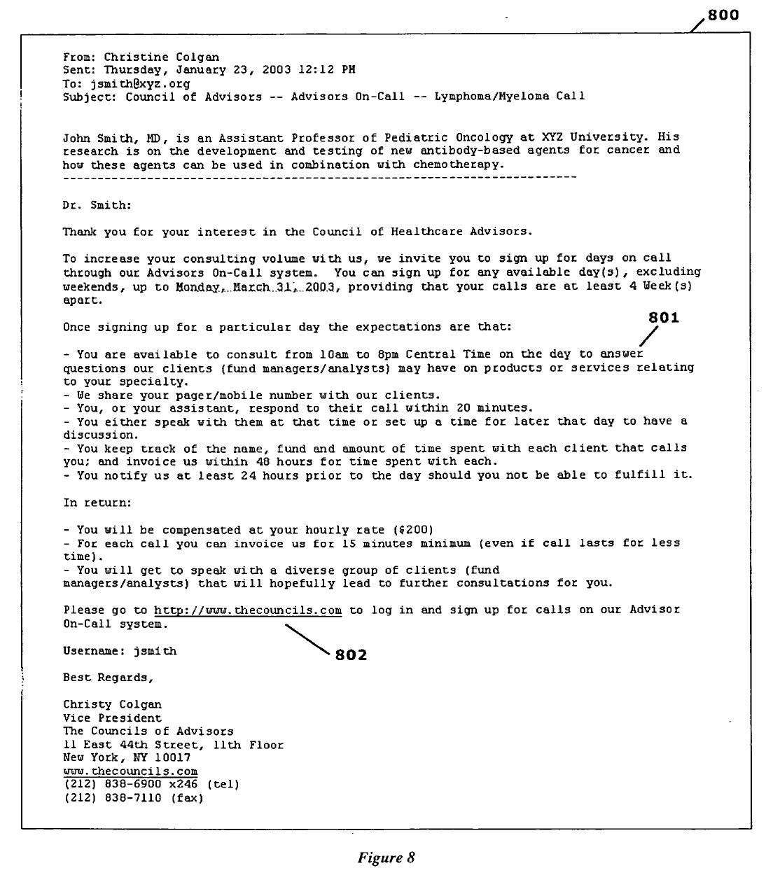

After setting the parameters 702, an Administrator can send email invitations (see FIG. 8) to participants in the group 306 by clicking an Invite button 705. A Manage On-Call Invites link 605 on screen 600 (see FIG. 6) allows for further invitations to be sent at a later date if necessary to one or more participants 307 in the group 306. This function is useful if new participants 307 are added to the group 306 once invitations 800 (see FIG. 8) have already been sent.

Returning now to the Invite screen 700, email invitations 800 are sent at step 103 (see FIG. 1A) to participants 301 when the Invite button 705 is clicked. The email invitation 800 comprises terms 801 of a preferred on call arrangement. The participant 307 clicks on a URL 802 to log in to a secure web site to sign up for on call dates. If the participant decides at step 104 not to sign up for on call dates, they do not click through and there is no further action for the current round of Invitations (see step 105 in FIG. 1A).

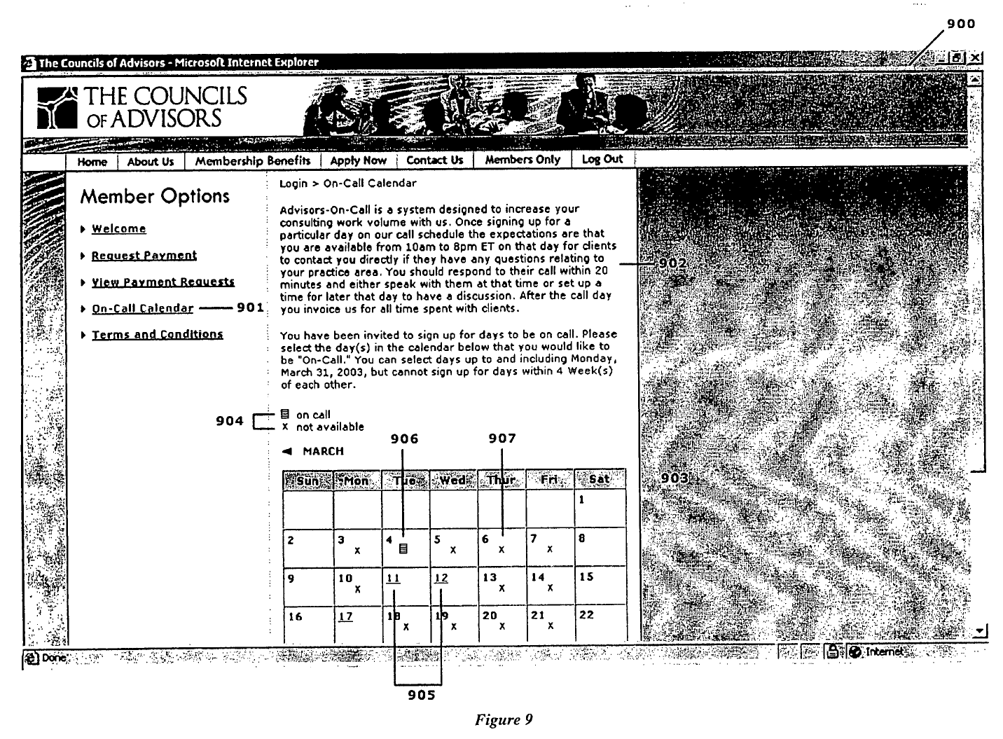

A participant 307 who logs in to the secure website 305 is taken to a calendar web page 900 (see FIG. 9) when they click on On Call Calendar link 901. The text 902 on the page 900 outlines the expectations for the participant 307. The calendar section 903 shows a month view of the calendar with icons 904 to represent dates that are not available to the participant 307. A striped box icon 906 represents a day that is not available because participant 307 already is on call that day. A cross icon 907 represents a day that is not available either because someone else in the group 306 is on call for that group specialty, or because participant 307 cannot sign up for a day that is within the Exclusion Range 704 following another call of theirs.

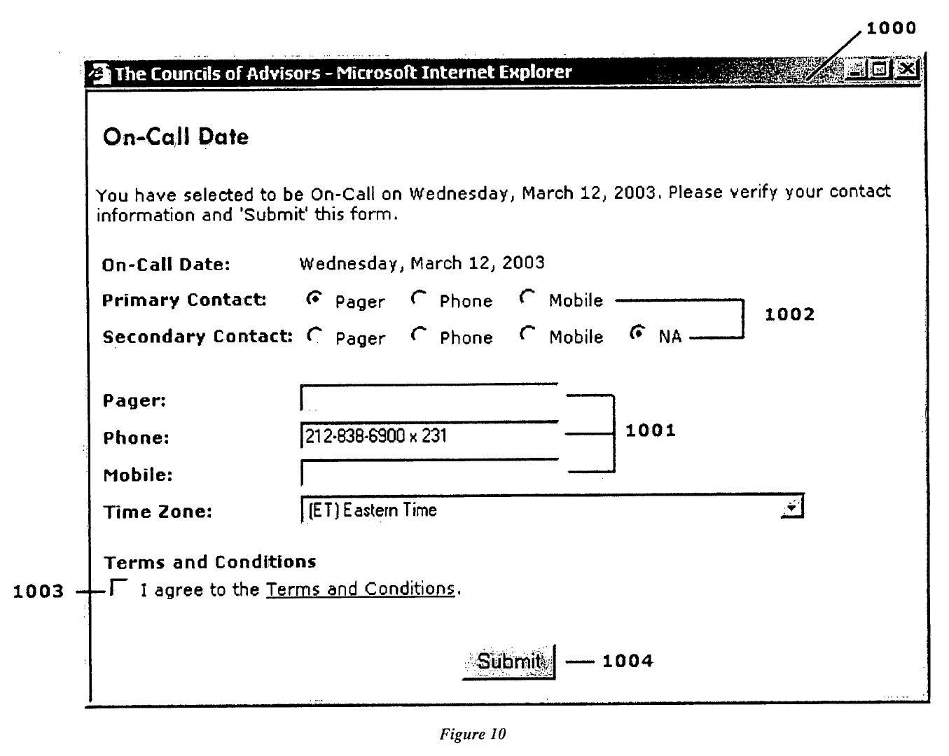

When a participant selects at step 106 an available day 905 on the calendar 903, they are taken to a web page 1000 (see FIG. 10) where they are required to fill in or verify their contact details 1001 and preferred mechanism of contact 1002 at step 107. They then indicate that they agree with the Terms and Conditions of the consulting arrangement by clicking checkbox 1003 and submit the form by clicking a “Submit” box 1004.

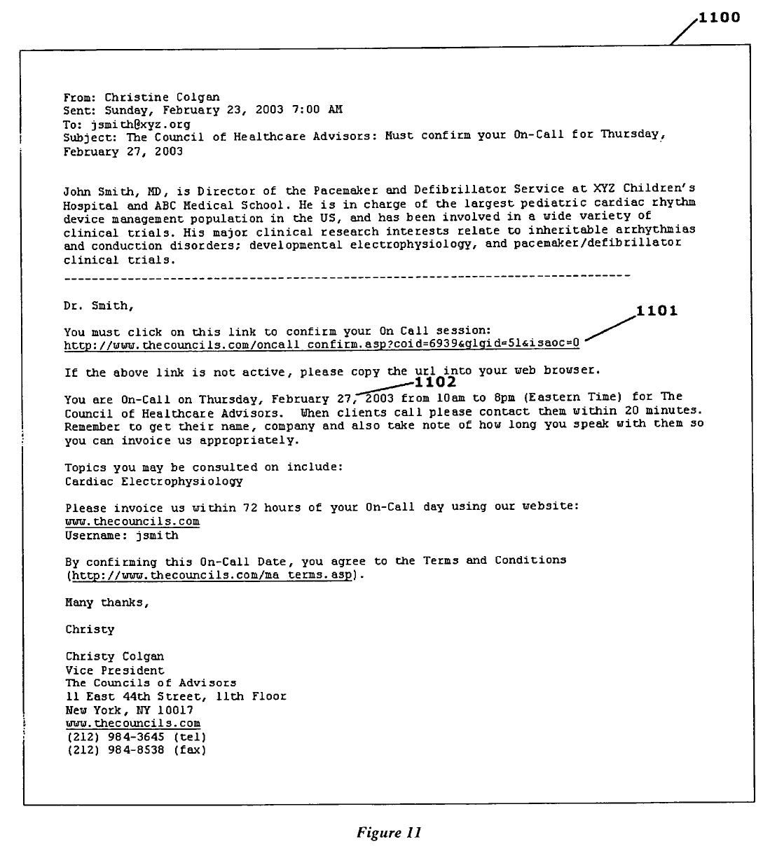

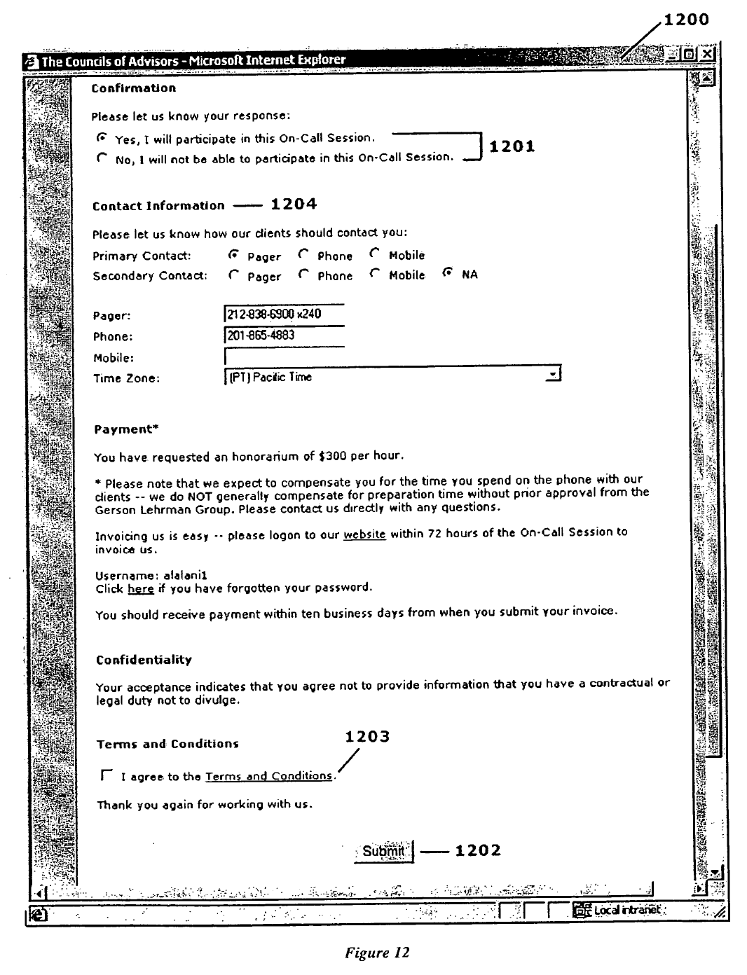

A day before the call date, the system 311 at step 108 sends a confirmation request email 1100 (see FIG. 11) to the participant 307 stating that the participant is required to click on a custom link 1101 to confirm that the participant will be on call on the specified date 1102. Clicking through on the custom link 1101 at step 112 (see FIG. 1A) takes the participant to a confirmation page 1200 (see FIG. 12) where the participant verifies his willingness to do the on call session by selecting an appropriate option 1201 and clicking a submit button 1202 after accepting the Terms & Conditions 1203 of the arrangement and verifying their contact information 1204.

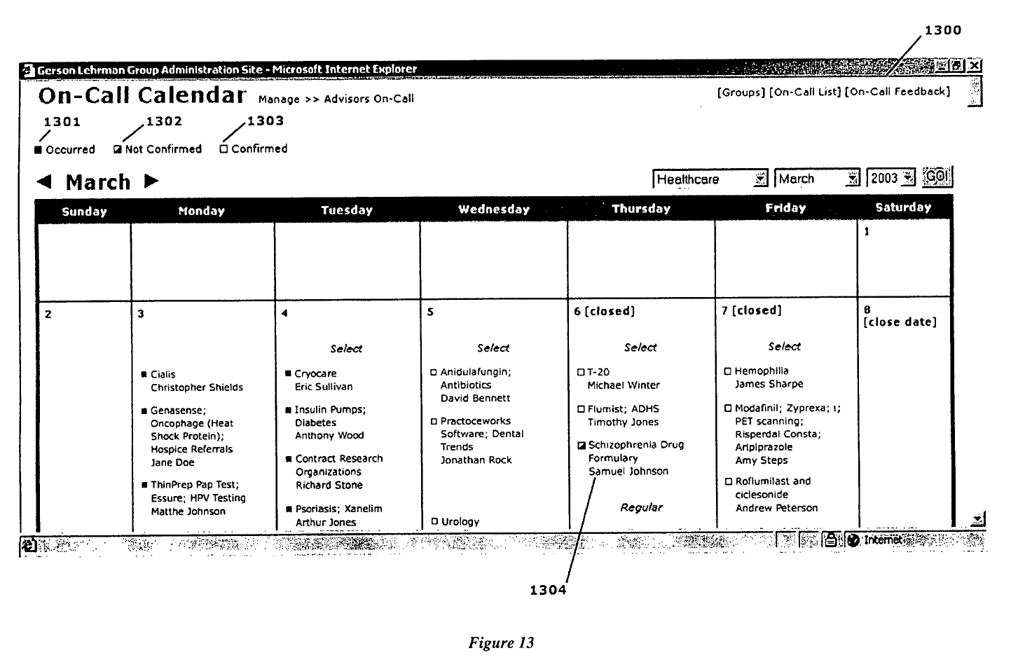

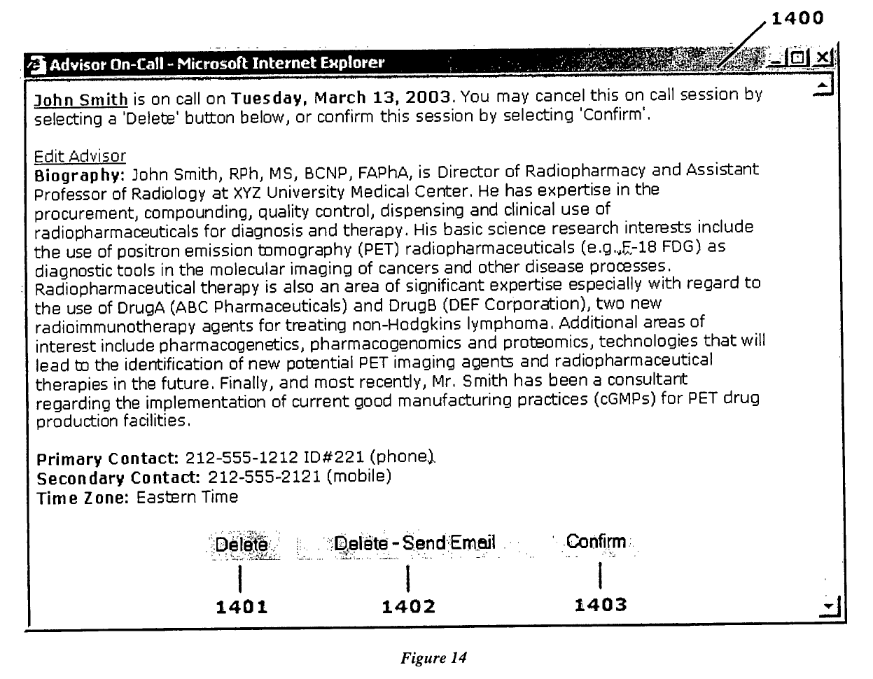

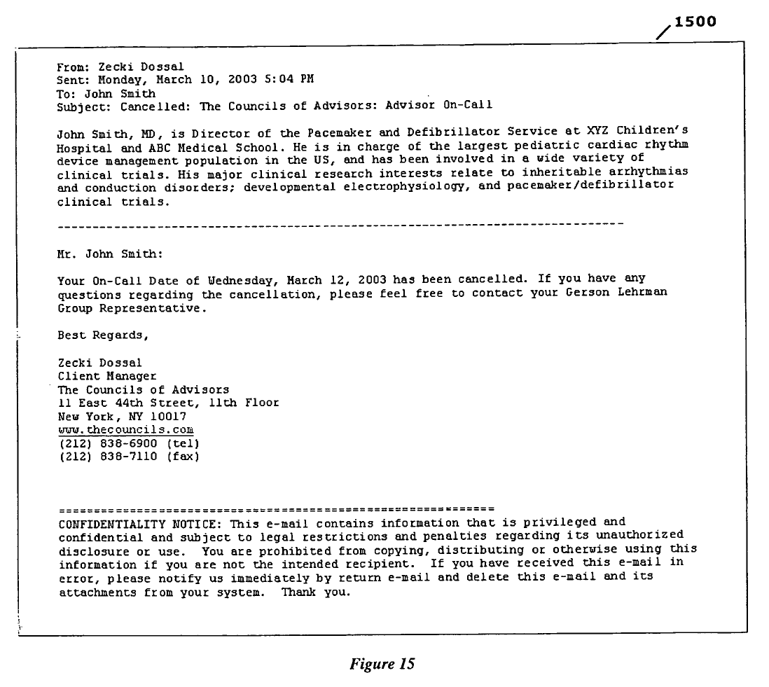

If the participant does not click the confirmation link at step 112, then at step 110 a flag on the Administrator's Calendar 1300 (see FIG. 13) indicates this via icons 1302. The Administrator then tries at step 111 to contact the participant 307 to confirm with them by other means. If the Administrator is able to reach the participant at step 114 and the participant 307 confirms the call date at step 116, then the Administrator confirms the on call date for the participant in the system directly at step 118 by clicking on the participant's name (1304) in the Calendar view 1300, thereby linking to a web page 1400 (see FIG. 14) for that specific participant 307's call day, where the confirmation can be made via the Confirm button 1403.

If the Administrator is not able to reach the participant at step 114, then the call cannot be confirmed or denied and the entry is ignored going forward (see step 115). If the Administrator reaches the participant and learns that the participant can no longer be on call that day, the Administrator can delete the call at step 117 using a Delete button 1401 (see FIG. 14). If the Administrator wishes to delete the call entry and send an email 1500 to the participant notifying him of the deletion, the Administrator would use the Delete & Send Email button 1402.

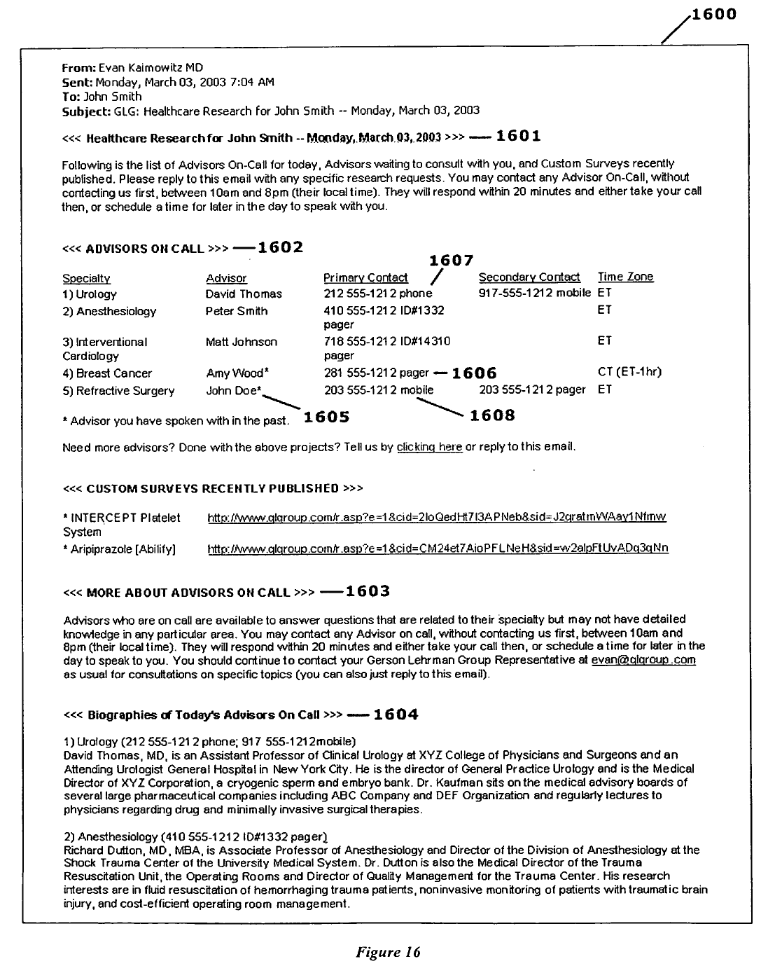

On the date of the call, the system 311 automatically generates at step 119 a personalized email 1600 (see FIG. 16) that is distributed to prospective callers 302 (see FIG. 3). The email 1600 contains a descriptive instruction section 1601 followed by an On Call List 1602, followed by further instruction and explanation 1603, and then a biographical detail section 1604. Part of the customization is a star 1605 next to any participant on call that the client has already spoken to (as tracked by the system 311).

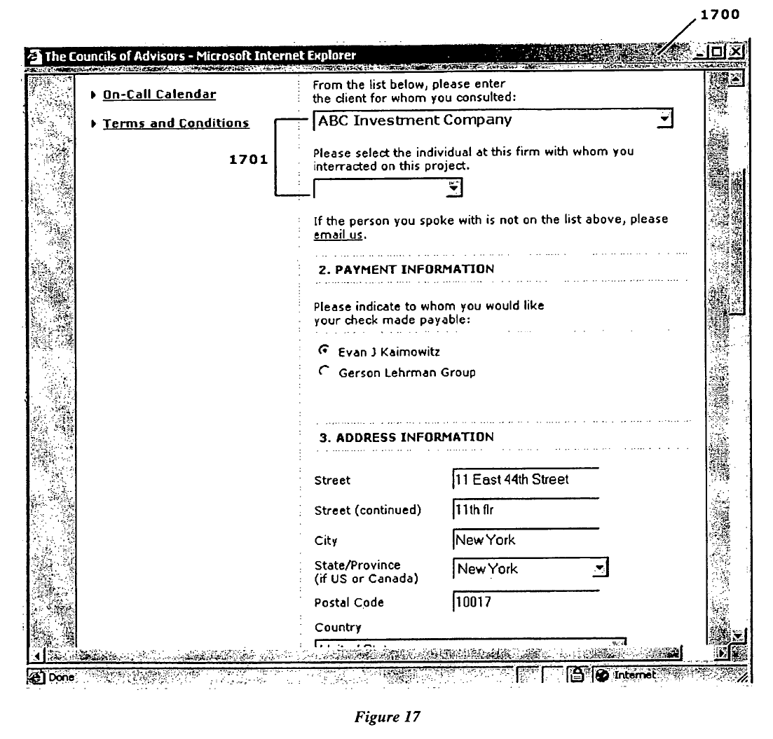

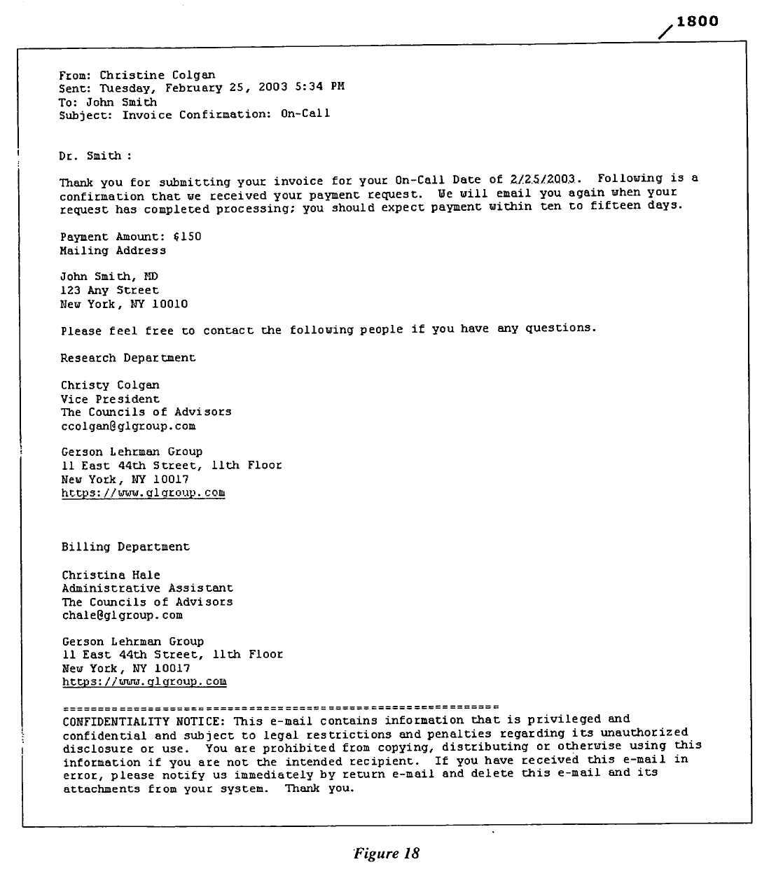

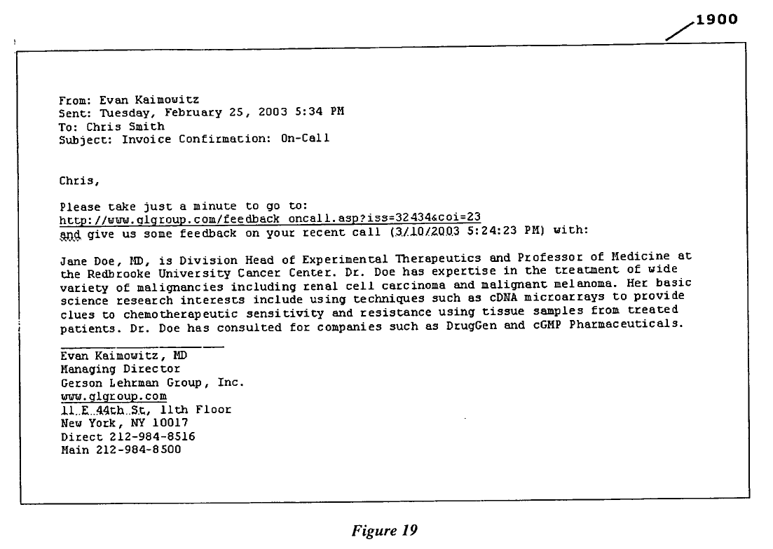

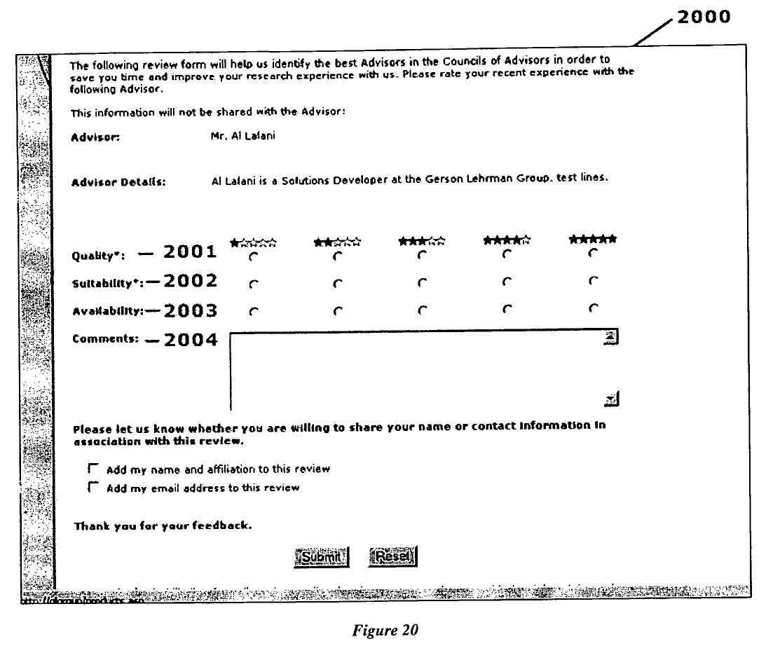

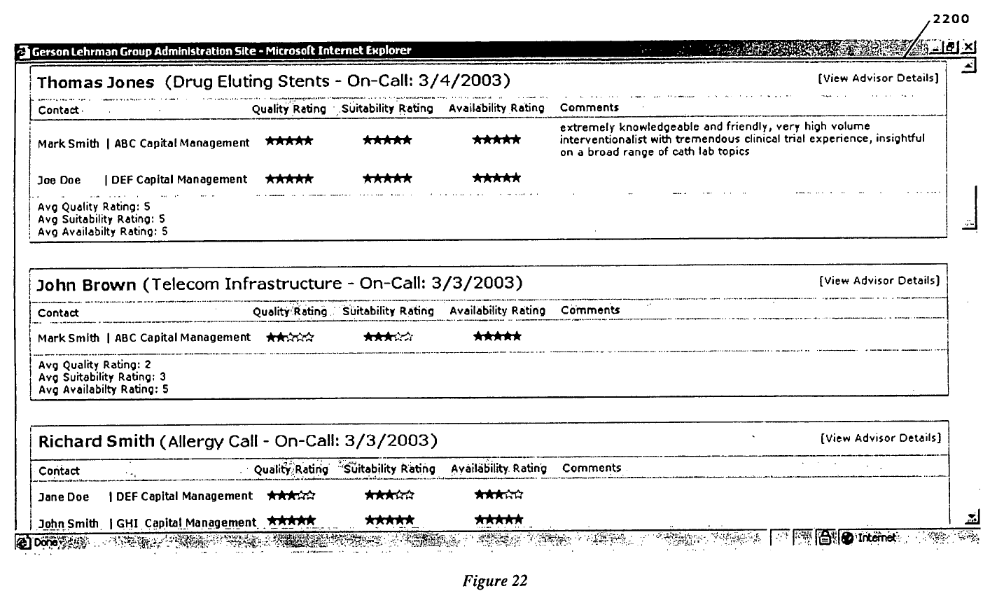

An individual caller 309 may read the list and decide to directly contact at step 120 (see FIG. 1B) any number of participants 301 on call that day. The caller may contact the participant by pager (1606), regular phone (1607), or mobile phone (1608) (see FIG. 16). After a call has concluded, the participant 307 at step 121 logs into the secure website and fills out an electronic invoice 1700 (see FIG. 17). The system 311 sends at step 122 to the participant a confirmation email 1800 (see FIG. 18) stating that an invoice has been filed. It then sends at step 123 to the caller 309 (as identified (1701) in the electronic invoice 1700) an email 1900 (see FIG. 19) requesting feedback on the call. The caller 309 then clicks on the URL at step 125 and fills out a feedback form 2000 (see FIG. 20) indicating quality (2001), suitability (2002), and availability (2003) scores, as well as qualitative commentary (2004). If the caller elects at step 129 not to click through and give feedback, no feedback is recorded, but the payment process (steps 127 and 128) proceeds unchanged. Feedback on participants can subsequently be viewed by the Administrator on a feedback screen 2200 (see FIG. 22).

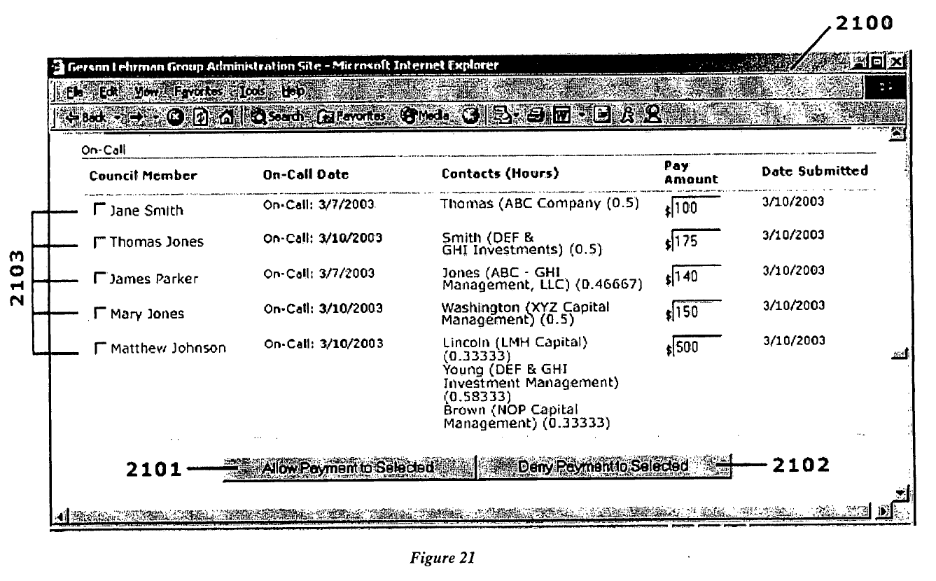

The Administrator 304 periodically looks (step 126) at an aggregated electronic invoice page 2100 (see FIG. 21) and allows at step 127 (see 2101) or denies at step 130 (see 2102) payments to individual participants (2103) using a conventional checkbox-then-submit-type-button method. Accepted payment requests are sent electronically through to the accounts payables department and a check is sent at step 128 to the participant 307 for services rendered.

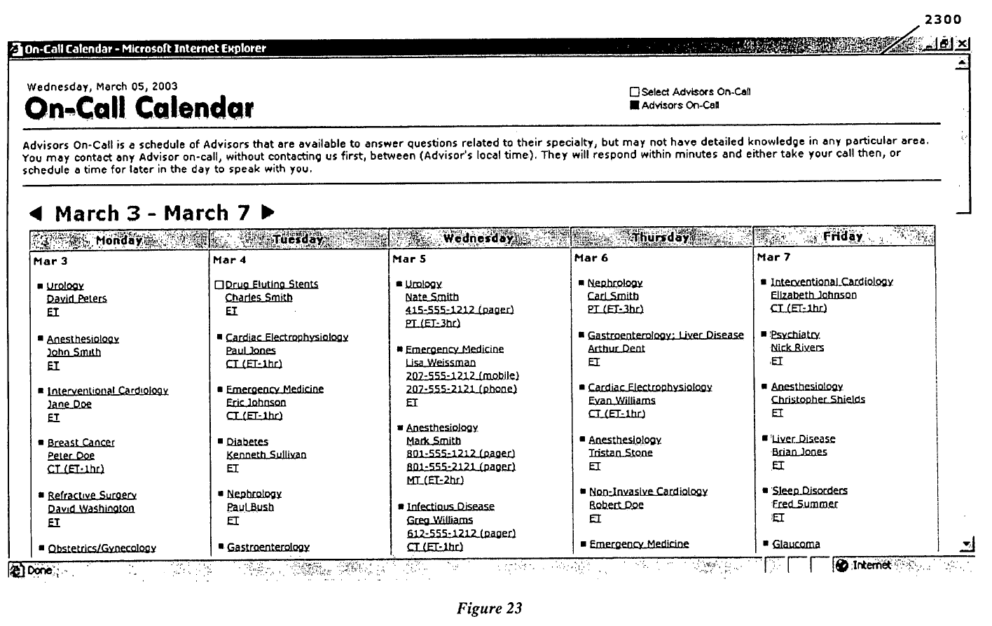

Should a prospective caller 309 want to plan ahead, they may log into a secure website and view a calendar 2300 (see FIG. 23) that lists participants expected to be on call in the following days and weeks.

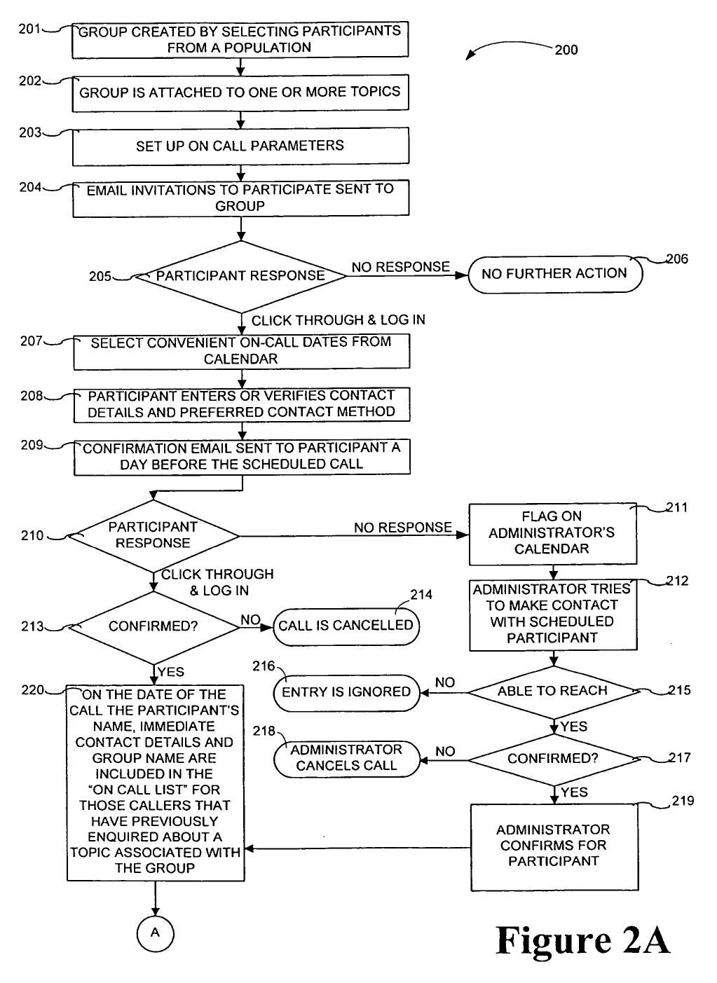

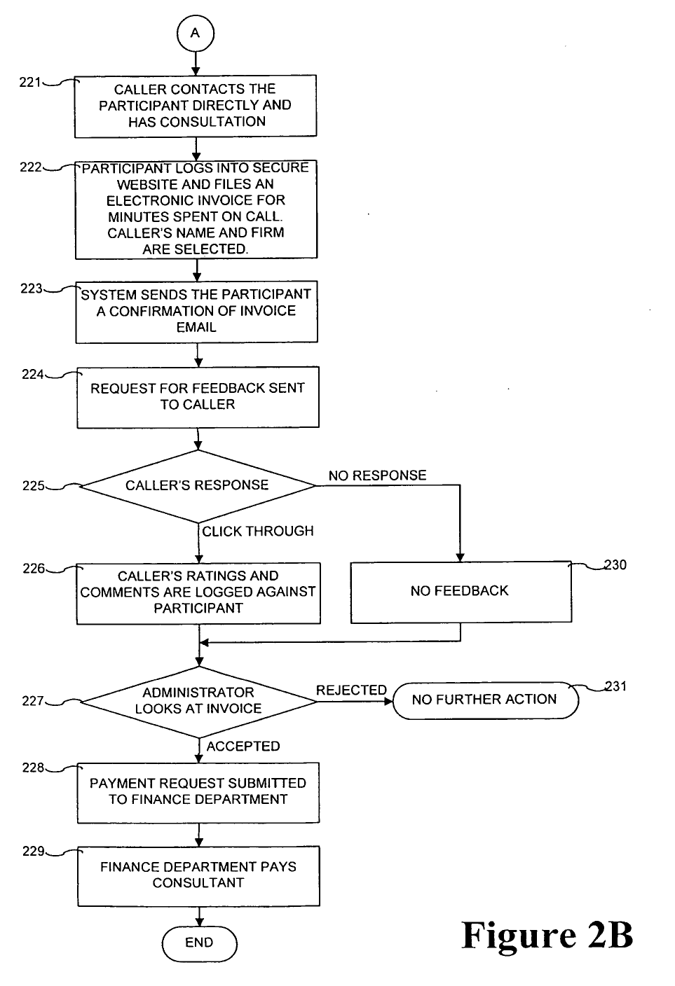

An alternate embodiment of the invention preferably is used in combination with the preferred embodiment. It provides for customization of the On Call List based on topics that callers have previously shown interest in. See FIGS. 2A and 2B. By using this method callers do not have access to the contact details of participants for topics they have not previously shown interest in, nor are they even aware of the topics. Caller interest is expressed through other activities, outside of the on call schedule. Such activities include requesting to speak with a participant on a given topic, attending events on a given topic, and downloading publications on a given topic.

The solid circle 308 in FIG. 3 indicates a caller who has expressed interest in a topic, whereas the empty circle 309 is a caller who has not. Only those callers who have expressed interest in the topic will receive the participant in their on call lists.

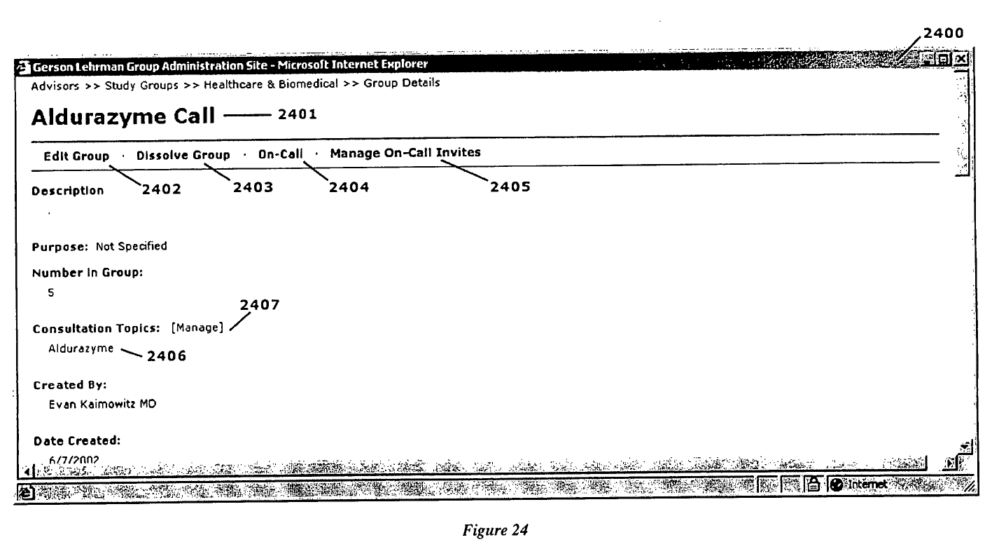

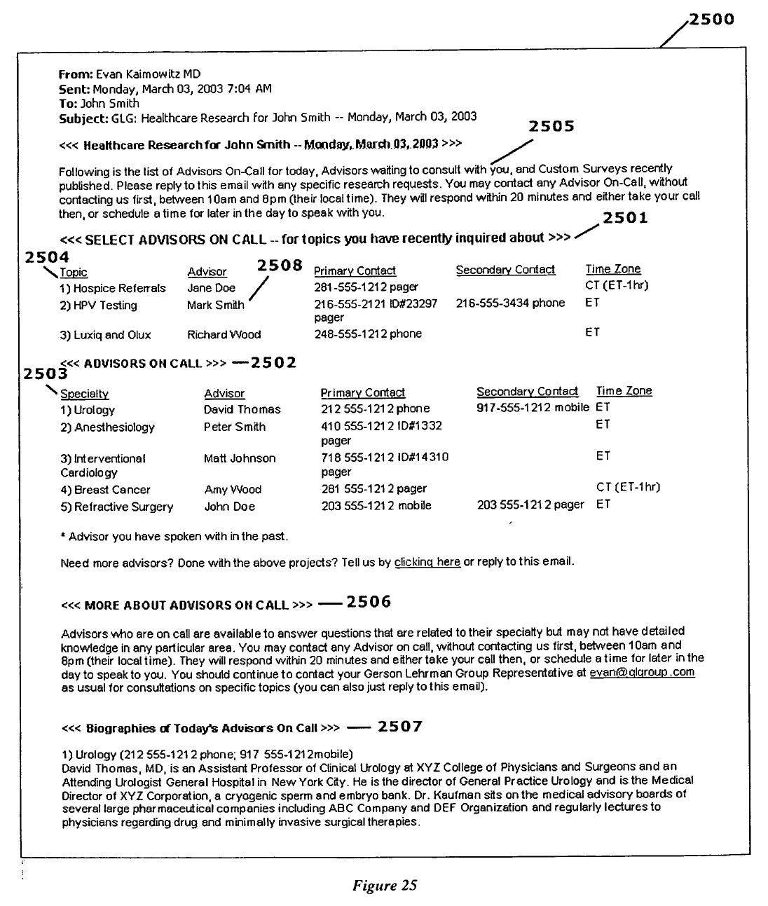

With reference now to the flowchart in FIG. 2A, an administrator 304 can, via the Internet 303 and website 305, at step 201 group participants 306 according to their expertise and store the groups in the SQL database 310. Such groups are given names and are listed on the website 305 as shown in FIG. 5. By selecting an individual group 501, an administrator 304 can view a web page 2400 (see FIG. 24) with more details and statistics on a specific group 2401. From that web page 2400 the administrator 304 can attach (step 202) one or more topics 2406 to the group 306 by using the Manage link 2407. The action of attaching (step 202) one or more topics to the group 306 differentiates this embodiment from that described above.

From the detailed web page 2400 the administrator 304 may elect to Edit (2402) the group or Dissolve (delete) (2403) the group. By electing at step 203 (see FIG. 2A) to Edit On Call parameters (2404), the administrator is directed to a screen 700 (see FIG. 7) specific for that group (701) which has editable fields 702. End Date (703) is the last day on which call dates are permitted. Exclusion Range (704) is the time period after a call date when a participant 307 will not be allowed to have another call.

After setting the parameters 702, an Administrator can send email invitations (see FIG. 8) to participants in the group 306 by clicking an Invite button 705. A Manage On-Call Invites link 2405 on screen 2400 (see FIG. 24) allows for further invitations to be sent at a later date if necessary to one or more participants 307 in the group 306. This function is useful if new participants 307 are added to the group 306 once invitations 800 (see FIG. 8) have already been sent.

Returning now to the Invite screen 700, email invitations 800 are sent at step 204 (see FIG. 2A) to participants 301 when the Invite button 705 is clicked. The email invitation 800 comprises terms 801 of the on call arrangement. The participant 307 clicks on a URL 802 to log in to a secure web site should they wish to sign up for on call dates. If the participant decides at step 205 not to sign up for on call dates, they do not click through and there is no further action for the current round of Invitations (see step 206 in FIG. 2A).

A participant 307 who logs in to the secure website 305 is taken to a calendar web page 900 (see FIG. 9) when they click on the On Call Calendar link 901. The text 902 on the page 900 outlines the expectations for the participant 307. The calendar section 903 shows a month view of the calendar with icons 904 to represent dates that are not available to the participant 307. A striped box icon 906 represents a day that is not available because they are already on call that day. A cross icon 907 represents a day that is not available either because someone else in the group 306 is on call for that group specialty, or because they cannot sign up for a day that is within the Exclusion Range 704 following another call of theirs.

When a participant selects at step 207 an available day 905 on the calendar 903, they are taken to a web page 1000 (see FIG. 10) where they are required to fill in or verify their contact details 1001 and preferred mechanism of contact 1002 at step 208. They then indicate that they agree with the Terms and Conditions of the consulting arrangement by means of a checkbox 1003 and submit the form by clicking a “Submit” box 1004.

A day before the call date, the system 311 at step 209 sends a confirmation request email 1100 (see FIG. 11) to the participant 307 stating that they are required to click on a custom link 1101 to confirm that they will be on call on the specified date 1102. Clicking through on the custom link 1101 at step 213 (see FIG. 2A) takes them to a confirmation page 1200 (see FIG. 12) where they verify that they can do the on call session by selecting an appropriate option 1201 and clicking a submit button 1202 after accepting the Terms & Conditions 1203 of the arrangement and verifying their contact information 1204.

If they do not click the confirmation link at step 210, then at step 211 a flag on the Administrator's Calendar 1300 (see FIG. 13) indicates this via icons 1302. The Administrator then tries at step 212 to contact the participant 307 to confirm with them by other means. If they are able to reach the participant at step 215 and the participant 307 confirms the call date at step 217, then the Administrator confirms the on call date for the participant in the system directly at step 219 by clicking on the participant's name (1304) in the Calendar view 1300, thereby linking to a web page 1400 (see FIG. 14) for that specific participant 307's call day, where the confirmation can be made via the Confirm button 1403.

If the Administrator is not able to reach the participant at step 215 then the call cannot be confirmed or denied and the entry is ignored going forward (see step 216). If the Administrator reaches the participant at step 215 and learns that the participant can no longer be on call that day at step 217, the Administrator can delete the call at step 218 using a Delete button 1401 (see FIG. 14). If the Administrator wishes to delete the call entry and send an email 1500 to the participant notifying of the deletion, they would use the Delete & Send Email button 1402.

On the date of the call, the system 311 generates at step 220 a personalized email 1600 (see FIG. 16) that is distributed to prospective callers 302 (see FIG. 3). Only those callers that have expressed interest in the topic, callers 308 (see FIG. 3) will receive the participant's details in their personalized email, in a distinct Select On Call section 2501 above the regular On Call section 2502. Whereas the regular On Call section has the group name 2503 of the group 304 (see FIG. 3) adjacent to the participant's name, the Select On Call section 2501 has the Topic name 2504 next to the respective participant. The system may determine said expressed interest by means of a direct topic match or by a child-parent taxonomy relationship in a topic taxonomy structure.

The email 2500 still contains a descriptive instruction section 2505 followed by the On Call Lists 2501 and 2502, followed by further instruction and explanation 2506, and then a biographical detail section 2507. Part of the customization is a star 2508 next to any participant on call that the caller has already spoken to (as tracked by the system 311).

An individual caller 309 may read the list and decide to directly contact at step 221 (see FIG. 2B) any number of participants 301 on call that day. They contact them either by pager (1606), regular phone (1607) or mobile phone (1608) (see FIG. 16). Once a call has been made, the participant 307 at step 222 once again logs into the secure website and fills out an electronic invoice 1700 (see FIG. 17). The system 311 sends at step 223 to the participant a confirmation email 1800 (see FIG. 18) stating that an invoice has been filed. It then sends at step 224 the caller 309 (as identified (1701) in the electronic invoice 1700) an email 1900 (see FIG. 19) requesting feedback on the call. The caller 309 then clicks on the URL at step 226 and fills out a feedback form 2000 (see FIG. 20) indicating quality (2001), suitability (2002) and availability (2003) scores, as well as qualitative commentary (2004). If the caller elects at step 225 not to click through and give feedback, no feedback is recorded, but the payment process (steps 228 and 229) is not affected. Feedback on participants can subsequently be viewed by the Administrator on a feedback screen 2200 (see FIG. 22).

The Administrator 304 periodically looks (step 227) at an aggregated electronic invoice page 2100 (see FIG. 21) and allows at step 228 (see 2101) or denies at step 231 (see 2102) payments to individual participants (2103) using a conventional checkbox then submit type button method. Accepted payment requests are sent electronically through to the accounts payables department and a check is sent at step 229 to the participant 307 for services rendered.

Should a prospective caller 308 want to plan ahead, they may log into a secure website and view a calendar 2300 (see FIG. 23) that lists participants expected to be on call in the following days and weeks. The calendar includes Select On Call participants 2301 and 2302 as part of the customization of the web page for that particular caller 308. A prospective caller who has not expressed interest in a topic 309 will not see the Select On Call participants related to that topic on the calendar 2300.

A further embodiment of the invention preferably is used in combination with the above embodiments. It provides for more automation with regard to the invitation process for participants. Whereas in the embodiments above it is necessary to construct a group of participants and trigger an email to them, this embodiment provides a method by which individual participants, outside of a group, are invited to participate in the on call program.

Callers trigger automated invitations by providing high feedback (that is, substantially positive feedback) on a call with a particular participant. If high feedback is given for a call where a topic was assigned, the participant is not already signed up for an on call day, the hourly billing rate is within a certain range, and sufficient callers have expressed interest in the topic, then an invitation is triggered. Caller interest also may be expressed through other activities, such as requesting to speak with a participant on a given topic, attending events on a given topic, and downloading publications on a given topic. Other activities to which the method is potentially applicable will be apparent to those skilled in the art.

Preferably the only restrictions preventing a participant from signing up for an on call day are: (1) it is a day on which they are already on call, or (2) it is in a 2-week lockout period (for example) following an on-call day. As opposed to the other embodiments described above, there is no participant group in this embodiment, so there is no restriction against participants signing up for a day on which someone else in the group has already signed up.

On the day of the call, callers that qualify as having expressed interest in the topic (and preferably only those callers) will receive the participant's name and contact details related to the topic of interest. The list of such participants preferably resides in a separate section of the on call list.

While the embodiments shown and described herein are fully capable of achieving the objects of the invention, it is to be understood that these embodiments are shown only for the purpose of illustration and not for the purpose of limitation. For example, those skilled in the art will recognize that computer-network-based chat rooms, instant messaging, and the like could be used in the above-described embodiments instead of telephone calls. Thus, the term “call” should be construed broadly, to cover such alternatives to telephone calls.

What is claimed is:

1. A method for scheduling call consultations, comprising:
receiving an electronic request from a first participant for one or more on call dates;
assigning one or more on call dates to said participant; and
notifying potential callers of said first participant's on call dates and qualifications.

2. A method as in claim 1, further comprising receiving electronic feedback information from one or more callers who have called said first participant during said one or more assigned on call dates; and recording said feedback information in an electronic database.

3. A method as in claim 1, further comprising assigning said participant to a group associated with a topic, and wherein a potential caller does not have access to contact information for said participant unless said potential caller has indicated an interest in said topic.

4. A method as in claim 3, wherein said interest is indicated by said potential caller requesting to speak with a associated with said topic.

5. A method as in claim 3, wherein said interest is indicated by said potential caller attending one or more events associated with said topic.

6. A method as in claim 3, wherein said interest is indicated by said potential caller downloading one or more publications related to said topic.

7. A method as in claim 2, further comprising:
associating said participant with a topic,
wherein a predetermined number of callers have expressed interest in said topic, and wherein said participant has received positive feedback for one or more calls related to said topic; and
transmitting an electronic invitation to said participant to request an on call date relating to said topic.
